(19) United States
(12) Patent Application Publication
(10) Pub. No.: US 2011/0147414 A1
(43) Pub. Date: Jun. 23, 2011

(54) Cap Device of Container

(75) Inventor: Ken-Te CHEN, Shanhua Town (TW)

(73) Assignee: GENMONT BIOTECH INC.

(21) Appl. No.: 12/644,012

(22) Filed: Dec. 22, 2009

(51) Int. Cl. B67D 1/00

(52) U.S. Cl. 222/83

(57) ABSTRACT

A cap device of container includes a seat portion and a flushing portion. The seat portion includes an inner circular wall and a bottom wall. The flushing portion has a circular column. The circular column has a lower cutting portion, two inclined cutting portions and a stopping portion. The lower cutting portion has several teeth, which are separate from each other. When the flushing portion is pressed downwards, the lower cutting portion cuts open the bottom wall and the two inclined cutting portions cuts open the peripheral area of the bottom wall until the stopping portion stops the cutting. Therefore, the additive contained in the space may be fall down to the bottle.

### BACKGROUND OF THE INVENTION

1. Field of the Invention

The invention generally relates to a cap device. More particularly, the invention relates to an improved cap device, in which an additive held in the cap device flows down to the bottle right before it is used.

2. Description of the Prior Art

A regular bottle container includes a bottle and a cap device fitted on top of the bottle. Various types of cap devices have been developed so as to separate the additive from the liquid contained in the bottle. The additive held in the cap device drops to the bottle only when it is ready to use. However, such cap device needs to be improved.

Please refer to FIGS. 1 and 2. A cap device 1 is fitted on a bottle 2. An opening 21 is formed on top of the bottle. The cap device 1 is connected with the opening 21 through a thread. The cap device 1 includes a seat portion 11, a membrane 12, a flushing portion 13 and a sealing portion 14. The seat portion 11 defines a space 15 to hold the additive. The membrane 12 is fitted on the bottom of the seat portion 11. The flushing portion 13 is fitted on top of the seat portion 11 and may be pressed downwards to cut open the membrane 12. The sealing portion 14 is detachable and is disposed between the seat portion 11 and the flushing portion 13. The flushing portion 13 has an inclined cutting portion 131.

When use, we first pull the sealing portion 14 away from the seat portion 11 and the flushing portion 13. Then, we press down the flushing portion 13 in the direction 16 shown in FIG. 3. Now, the inclined cutting portion 131 can move downwards to cut open the membrane 12. Therefore, the additive held in the space 15 may flow down to the bottle 2.

Though the cap device can hold the additive until it is ready to use, the membrane 12 is a thin aluminum membrane and the membrane has to be attached to the bottom of the seat portion 11. Therefore, production cost is higher and the use of such membrane is not very healthful. In addition, a crack may appear between the membrane and the bottom of the seat portion 11 when the membrane deformed due to heat. In such case, its sealing function disappears.

In addition, as shown in FIGS. 3 and 4, the inclined cutting portion 131 has an inclined cutting blade 132. During cutting, the cut-open part 121 of the membrane 12 hinders the cutting action of the cutting blade 132 (because the membrane 12 may curl upwards). Therefore, though most of the membrane 12 may be cut open, the additive may be hindered by the remaining portion of the membrane 12. In addition, if cutting can be done easily and quickly, the membrane 12 may accidentally fall into the bottle 12. Therefore, the cap device 1 of the prior art needs to be improved.

### SUMMARY OF THE INVENTION

The object of the present invention is to provide an improved cap device (and a bottle) that can hold and allow an additive to flow down to the bottle.

To reach the goal, an improved cap device of the present invention is disclosed. The improved cap device of the present invention comprises a seat portion and a flushing portion. The flushing portion is fitted inside the seat portion. The seat portion includes an inner circular wall and a bottom wall. The inner circular wall and the bottom wall jointly define a space, which may hold an additive. The flushing portion includes a top plate and a circular column. The top plate seal off the flushing portion and the circular column extends downwards to the space. The circular column is fitted inside the inner circular wall and is above the thinner portion. The circular column has a lower cutting portion, two inclined cutting portions and a stopping portion. The lower cutting portion is located in the lower part of the circular column and the two inclined cutting portions extend upwards and away from the lower cutting portion 524. The stopping portion can limit the cutting action.

### BRIEF DESCRIPTION OF THE DRAWINGS

FIG. 1 is a perspective view illustrating a conventional cap device.

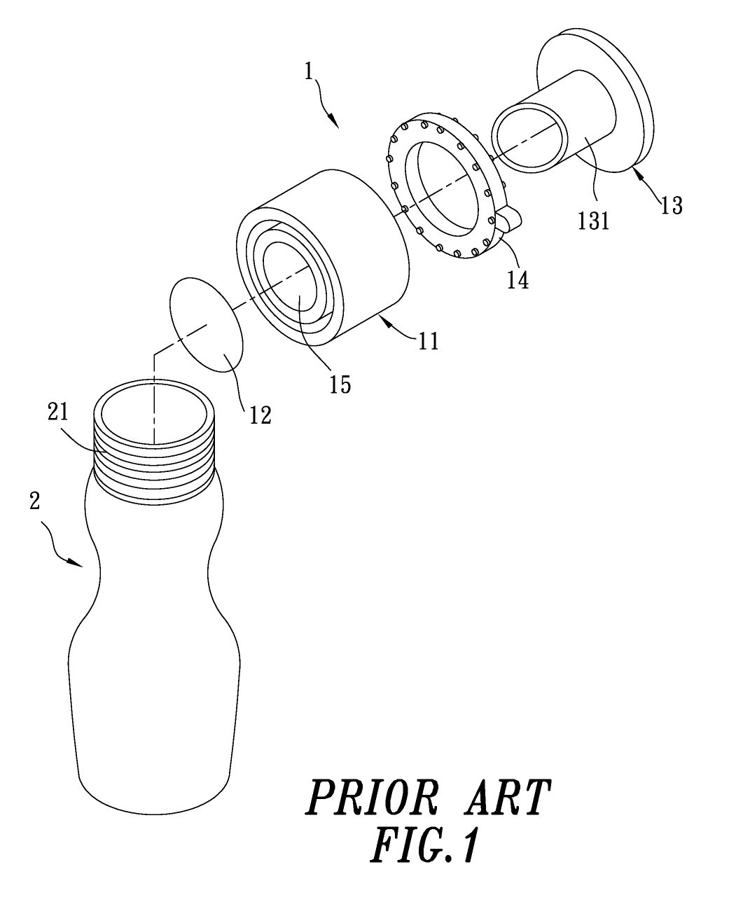

FIG. 2 is a sectional view illustrating a conventional cap device in an assembled condition, showing that the movement of the flushing portion is limited by a sealing portion.

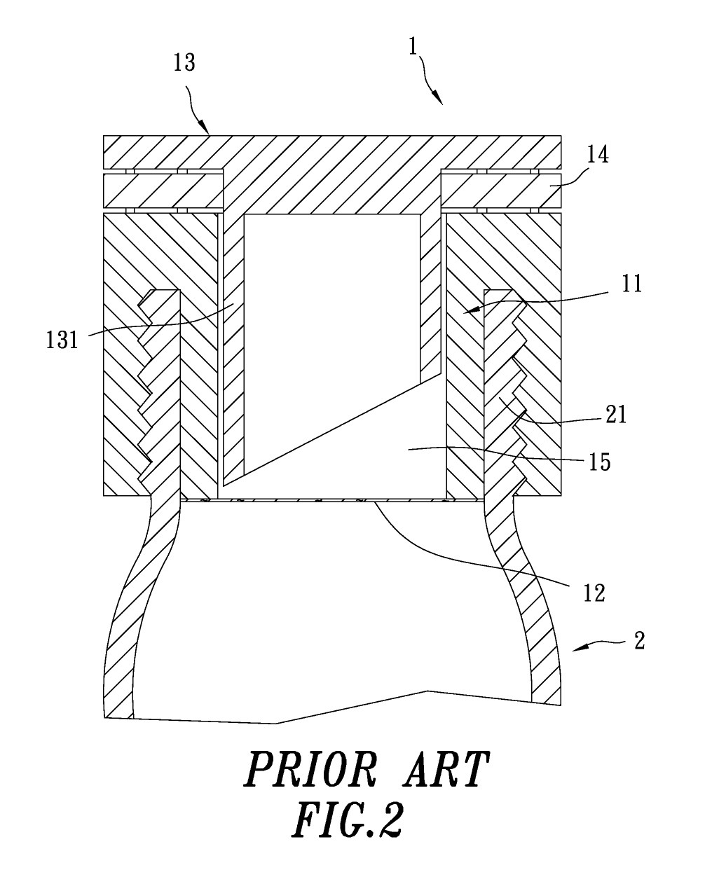

FIG. 3 is a sectional view illustrating a conventional cap device, showing that the sealing portion is removed and the flushing portion is pressed downwards to cut open a membrane.

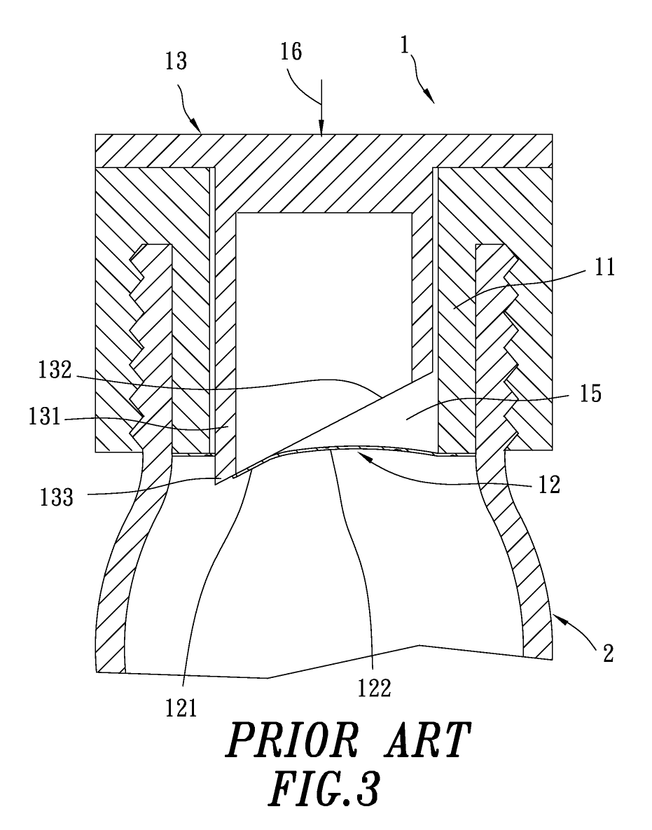

FIG. 4 is a top view illustrating a conventional cap device, showing that the membrane is cut open.

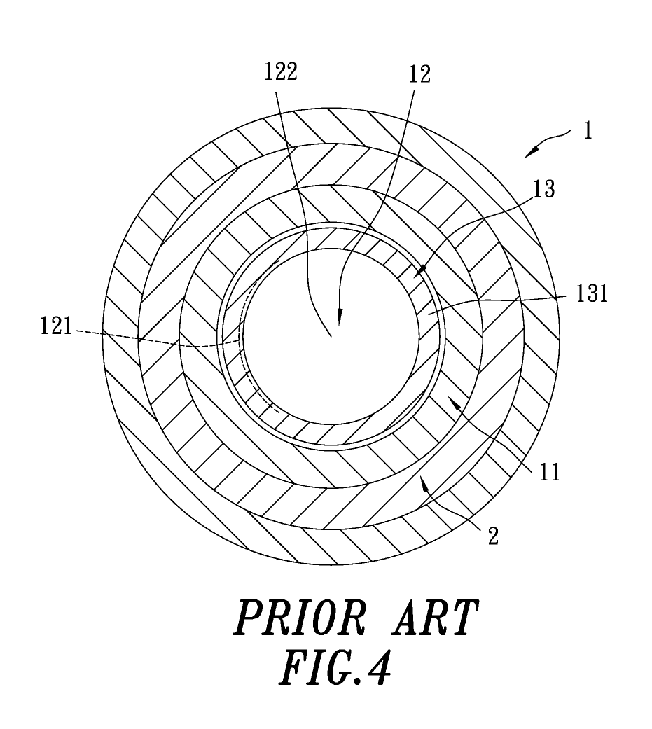

FIG. 5 is a perspective view illustrating a preferred embodiment of the present invention.

FIG. 6 is a sectional view illustrating the preferred embodiment of the present invention.

FIG. 7 is a sectional view illustrating the preferred embodiment of the present invention, showing that the movement of the flushing portion is limited by the protective portion and the flushing portion is at a non-flushing-cutting position.

FIG. 8 is a sectional view illustrating the flushing-cutting portion is moved to a flushing-cutting position after the protective portion is removed.

FIG. 9 is a top view illustrating the flushing portion is at the flushing-cutting position.

### DETAILED DESCRIPTION OF THE PREFERRED EMBODIMENTS

The features and advantages of the present invention will be fully understood and appreciated from the following detailed description of the accompanying Drawings.

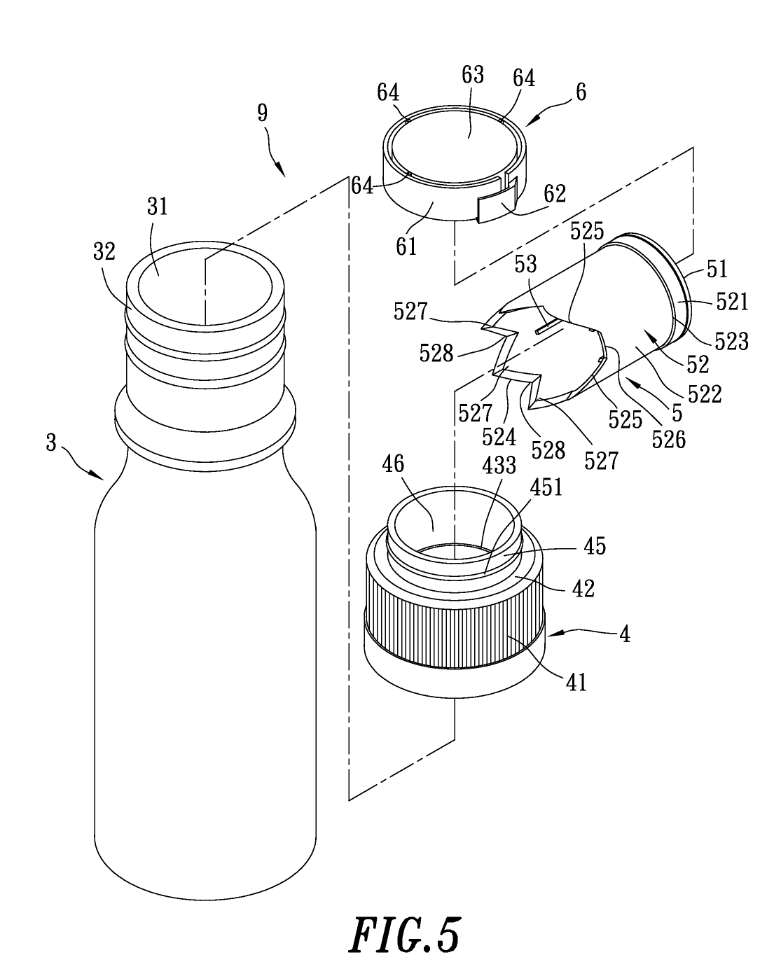

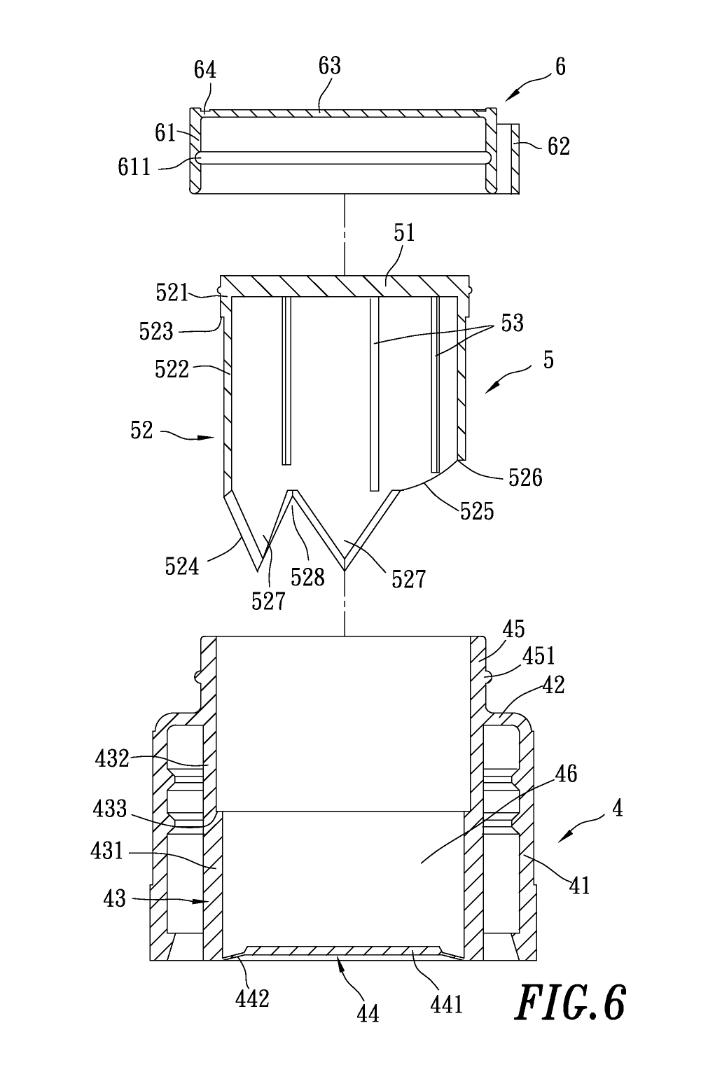

Please refer to FIGS. 5, 6 and 7, which illustrate a preferred embodiment of the present invention. The improved cap device of the present invention comprises a bottle 3 and a cap device 9 fitted on top of the bottle 3. The bottle 3 defines a space 31 to contain liquid and the bottle 3 has an opening 32 on the top. The liquid can be drinks, medicinal liquid, cleaning agent or pure water.

Again, the cap device 9 is fitted on top of the bottle 3. The cap device 9 includes a seat portion 4, a flushing portion 5 and a protective portion 6. The seat portion 4 may be fitted onto the opening 32. The flushing portion 5 may be moved downwards to be fitted onto the seat portion 4. The protective portion 6 is detachable and is fitted onto top of the flushing portion 5.

The seat portion 4 is made of a plastic material and is integrally formed. The seat portion 4 includes an outer circular wall 41, an upper circular wall 42, an inner circular wall 43, a bottom wall 44 and a connecting wall 45. The outer circular wall 41 may be connected with the outer wall of the opening 32 through a thread. The upper circular wall 42 is a portion extending upwards and is below the height of the opening 32. The inner circular wall 43 extending from the inner side of upper circular wall 42 is in contact with the inner surface of the opening 32. The bottom wall 44 seal off the inner circular wall 43. The connecting wall 45 extends upwards from the inner circular wall 43. The inner circular wall 43 and the bottom wall 44 jointly define a space 46, which may hold an additive. Such additive may be probiotics, microorganisms, spores, food, drugs, cleaning agent and edible beauty enhancement products (may be in powder, liquid or particles). The inner circular wall 43 has a lower portion 431, an upper portion 432 and a shoulder portion 433. The inner diameter of the upper portion 432 is a large than that of the lower portion 431. The lower portion 431 is connected with the upper portion 432 through the shoulder portion 433. The bottom wall 44 has a thicker portion 441 and a thinner portion 442. The thicker portion 441 is centrally located. The thinner portion 442 extends radially from thicker portion 441 to the inner circular wall 43. The thickness of the thinner portion 442 decreases in the radial direction. The connecting wall 45 has a connective portion 451, which is formed on the outer surface.

The flushing portion 5 is made of a plastic material and is integrally formed. The flushing portion 5 includes a top plate 51, a circular column 52 and several strips 53. The top plate 51 can seal off the space 46. The circular column 52 extends from the top plate 51 to the space 46. The strips 53 are parallel to each other and are oriented in the axial direction. The purpose of the strips 53 is to strengthen the circular column 52. Therefore, the circular column 52 may be thinner or the circular column 52 may be made of a softer material.

The circular column 52 is circular and is fitted inside the inner circular wall 43. The circular column 52 includes an upper portion 521, a lower portion 522, a shoulder portion 523, a lower cutting portion 524, two inclined cutting portions 525, a stopping portion 526. The upper portion 521 extends downwards from the top plate 51. The outer diameter of the lower portion 522 is smaller than that of the upper portion 521. The shoulder portion 523 connects the upper portion 521 with the lower portion 522. The lower cutting portion 524 is located near the lowest point of the lower portion 522. The two inclined cutting portions 525 extend upwards and away from the lower cutting portion 524. The stopping portion 526 is connected to the uppermost point of the two inclined cutting portions 525. The lower cutting portion 524, two inclined cutting portions 525 and stopping portion 526 form a ring-like configuration.

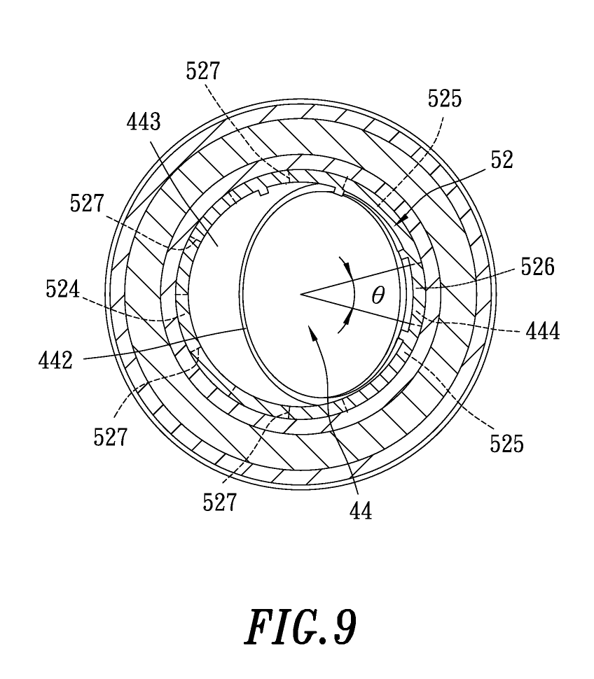

The lower cutting portion 524 has several cutting teeth 527 and several indented areas 528 located between each pair of the teeth 527. The cutting teeth 527 are separate from each other. Each cutting tooth 527 has the same distance between its lowest point of and the bottom wall 44. Each cutting tooth 527 becomes narrower or sharper in the descending direction. The stopping portion 526 is an arc section. The stopping portion 526 corresponding to an angle, which is in the range from 22 to 42 degree (please see FIG. 9). If the angle is less than 22 degree, the stopping portion 526 is too short and is prone to breakage. If the angle is larger than 42 degree, the stopping portion 526 is too long and less room is available for the lower cutting portion 524 and the two inclined cutting portions 525. Therefore, in this case, the range of cutting on the peripheral portion of the bottom wall 44 would be reduced. The optimal angle is 32 degree.

The protective portion 6 is made of a plastic material and is integrally formed. The protective portion 6 includes a sealing strip 61, a handle 62, a top plate 63 and several connective pieces 64. The sealing strip 61 is detachable and may be fitted on top of the connecting wall 45. The handle 62 is connected with the sealing strip 61 and a user can have a grip on the handle 62. The top plate 63 is fitted on top of the top plate 51. The connective pieces 64 connect the top plate 63 with the sealing strip 61. The sealing strip 61 has a connective portion 611, which extends inwards and may be connected with the connective portion 451. Through the protective portion 6 (which is fitted on top of the flushing portion 5) and the connection between connective portion 611 and the connective portion 451 can prevent a user from accidentally pressing down on the flushing portion 5.

When we use the device, we hold the handle 62 and pull it outwards. Now, the sealing strip 61 and the top plate 63 are removed and the protective portion 6 is removed to expose the top plate 51. Now, the flushing portion 5 is at a non-flushing-cutting position. The shoulder portion 523 is above the shoulder portion 433 and the stopping portion 526 is above the bottom wall 44. Therefore, the flushing portion 5 may move further downwards.

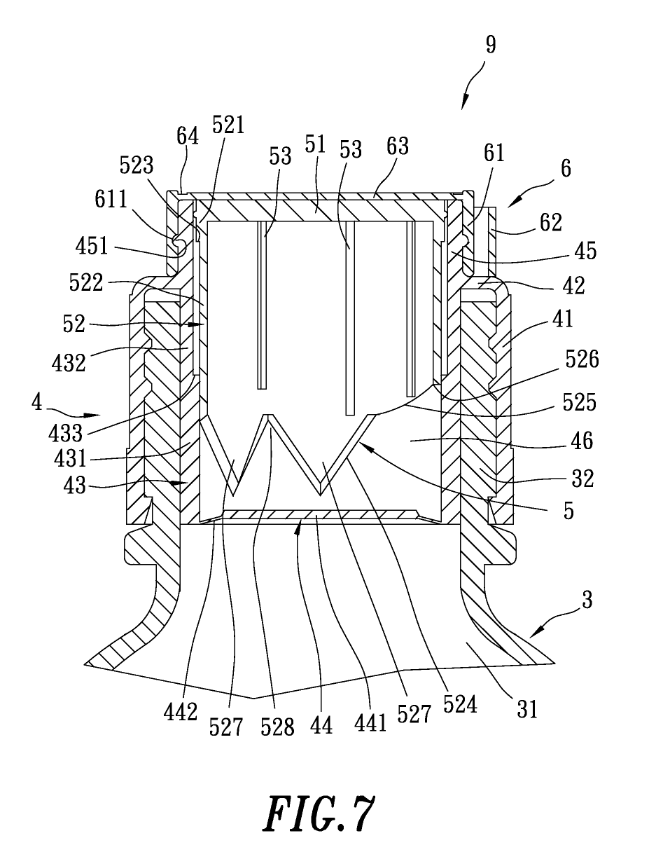

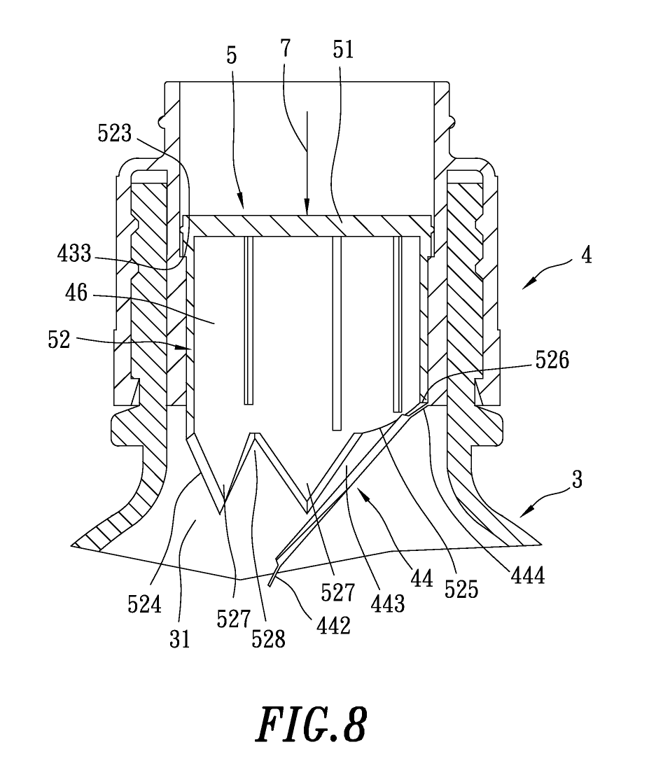

Now, the user presses the top plate 51 in the direction shown in FIG. 8. At this moment, the flushing portion 5 moves from the position 7 showed in FIG. 7 and to the position shown in FIGS. 8 and 9. The cutting teeth 527 moves downwards and cut open a part of the bottom wall 44 and keeps on moving downwards to cut open the thinner portion 442. Now, a cut-open crack is formed. The cutting continues until the stopping portion 526 pressed against a connective portion 444. Now, the shoulder portion 523 presses against the shoulder portion 433. Therefore, the circular column 52 can not move downwards. Therefore, the bottom wall 44 would not be completed cut open. Also, the stopping portion 526 presses against the bottom wall 44. Now, the additive held in the space 46 falls into the liquid space 31 of the bottle 3 through the cracks 443 and indented areas 528. After the additive is mixed up with the liquid, the mixed solution is ready to use. In this embodiment, the liquid held in the bottle is a drink and the additive is Lactobacillus, or other types of probiotics. In use, these two ingredients are mixed to produce a drink with Lactobacillus, or other types of probiotics.

From the above, we can see that the liquid held in the liquid space 31 of the bottle 3 and the additive held in the space 46 of the cap device are separated from each other until they are ready to use. Therefore, they are fresher and may be kept longer because the pre-mixing of them may cause sediment and such mixture may be prone to deterioration.

The stopping portion 526 allows the lower cutting portion 524 and two inclined cutting portions 525 to cut open the bottom wall 44 and limits the cutting range (so that the bottom wall 44 would not curl upwards). Also, the part that is cut open would not block the passage of the additive. The cutting action would cut open the entire bottom wall 44; otherwise, it would drop into the bottle 3.

During the cutting action, the cutting teeth 527 may cut open the bottom wall 44 quickly by piercing the peripheral area of the bottom wall 44. In addition, the indented areas 528 allow the passage of the additive. In addition, the tapering design of the peripheral area 442 guides the cutting action and facilitates the cutting of the lower cutting portion 524 and two inclined cutting portions 525. In addition, the cutting teeth 527 can last through the whole cutting action without becoming blunt.

The seat portion 4 is made of a plastic material and is formed integrally. Because no membrane is needed (in comparison to the prior art), production cost is lowered and no membrane would accidentally drop into the bottle. In addition, because the bottom wall 44 and the inner circular wall 43 are integrally formed, there would be no crack generated due to heat. This can assure that the additive and the liquid in the bottle are separated (to avoid deterioration).

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A cap device, comprising:
a seat portion (4), having an inner circular wall (43) and a bottom wall (44), wherein the inner circular wall (43) extending from inner side of an upper circular wall (42) is in contact with inner surface of an opening (32), and the inner circular wall (43) and the bottom wall (44) jointly define a space (46); and
a flushing portion (5), fitted inside a seat portion (4), including a top plate (51), a circular column (52) and a plurality of strips (53), wherein the top plate (51) can seal off the space (46) and the circular column (52) extends from the top plate (51) to the space (46), wherein the circular column (52) is fitted inside the inner circular wall (43) and is above a thinner portion (442) and the circular column (52) has a lower cutting portion (524) and two inclined cutting portions (525), wherein the lower cutting portion (524) is located in lower part of the circular column (52) and the two inclined cutting portions (525) extend upwards and away from the lower cutting portion (524),
wherein the flushing portion (5) may be pressed downwards to move from a non-flushing-cutting position to a flushing-cutting position, at the non-flushing-cutting position, the lower cutting portion (524) approaches the bottom wall 44, at the flushing-cutting position, the lower cutting portion (524) cuts open the bottom wall (44), wherein the two inclined cutting portions (525) cut open an peripheral area of the bottom wall (44) to allow a passage of additive through a plurality of indented areas (528) and part that is cut open.

2. The cap device as in claim 1, wherein the flushing portion (5) has two inclined cutting portions (525) and a stopping portion (526), the two inclined cutting portions (525) extend upwards and away from the lower cutting portion (524) and the stopping portion (526) is disposed above the inclined cutting portions.

3. The cap device as in claim 1, wherein the lower cutting portion (524) has a plurality of cutting teeth (527) and the indented areas (528) located between each pair of the teeth, and the cutting teeth are separate from each other and each cutting tooth becomes narrower or sharper in a descending direction.

4. The cap device as in claim 1, wherein the bottom wall (44) has a thicker portion (441) and the thinner portion (442), and the thicker portion (441) is centrally located and a thickness of the thinner portion (442) decreases in a radial direction.

5. The cap device as in claim 1, further comprising a protective portion (6) which is detachable and is fitted on top of the flushing portion (5) to protect the flushing portion (5).

6. The cap device as in claim 1, wherein the strips 53 are parallel with each other and extend in a downward axial direction.
